(19) United States
(12) Patent Application Publication
(10) Pub. No.: US 2022/0061401 A1
(43) Pub. Date: Mar. 3, 2022

(54) Torch Adapter for Inhalable Concentrates

(71) Applicants: Brendan Patrick Charest, Edmonton (CA); Joseph Baxter, St. Albert (CA)

(72) Inventors: Brendan Patrick Charest, Edmonton (CA); Joseph Baxter, St. Albert (CA)

(21) Appl. No.: 17/464,180

(22) Filed: Sep. 1, 2021

Related U.S. Application Data
(60) Provisional application No. 63/073,372, filed on Sep. 1, 2020.

(51) Int. Cl. A24F 42/60

(52) U.S. Cl. CPC A24F 42/60

(57) ABSTRACT

An adapter for supporting a vaporizable concentrate product on a torch in a position heatable thereby to release inhalable concentrate vapor. The adapter has a first end, an opposing second end, an attachment element residing proximate said first end and configured for attachment to said torch to support the adapter thereon, and a receptacle residing proximate said second end and configured to hold said vaporizable concentrate therein. Installed on the torch with the attachment element engaged around a flame tube of the torch, the adapter places the receptacle in working relation to an outlet end of the flame tube for heating of the receptacle via the flame emitted from the outlet end of the flame tube. The receptacle is movably supported on the adapter to enable optimized placement thereof relative to the outlet end of the flame tube.

### CROSS-REFERENCE TO RELATED APPLICATIONS

This application claims benefit under 35 U.S.C. 119(e) of U.S. Provisional Application No. 63/073,372, filed Sep. 1, 2020, the entirety of which is incorporated herein by reference.

### FIELD OF INVENTION

The present invention relates generally to smoking apparatuses, more specifically but not by way of limitation, an adapter configured to be releasably secured to a torch wherein the adapter provides a technique for heating and subsequent inhalation of cannabis concentrates.

### BACKGROUND

As is known in the art, smoking various herb, concentrates and tobacco products have been practiced for thousands of years. Ancient rituals in many cultures included smoking various products utilizing a plurality of alternate devices. These devices range from conventional pipes, hookahs and many other types of devices. The aforementioned products are utilized to burn and inhale conventional leaf or herb type formats.

Over the last decade cannabis has had an explosion in popularity and legal acceptance in many parts of the world and United States. In addition to recreational use many are discovering the benefits of consumption of cannabis. There are numerous methods for cannabis consumption which can include creams, edibles and of course inhalation. For the latter there are alternate manners in which the cannabis can be consumed. One popular form of cannabis is referred to as concentrates. Concentrates allow a user to experience cannabis in a different way and one benefit of concentrates is the rapid onset and the ability to yield a high more potent than other forms of cannabis. Concentrates can come in a variety of textures and can be consumed utilizing several different methods with one method of consumption being utilization of a torch. A conventional butane torch can be used to heat a receptacle in which the concentrate is disposed, and from which the user will subsequently inhale the vapors/smoke released therefrom.

In view of this rising popularity of inhalable cannabis concentrates, there is a need for devices that facilitate convenient and safe torch-based vaporization and inhalation of such concentrates.

### SUMMARY OF THE INVENTION

According to one aspect of the invention, there is provided an adapter for supporting a vaporizable concentrate product on a torch in a position heatable thereby to release inhalable concentrate vapor, said adapter having a first end, an opposing second end, an attachment element residing proximate said first end and configured for attachment to said torch to support the adapter thereon, and a receptacle residing proximate said second end and configured to hold said vaporizable concentrate product therein.

Preferably said attachment element is annular in shape.

Preferably said concentrate receptacle comprises a bowl.

Preferably said receptacle is movably supported.

Preferably said receptacle is movable upwardly and downwardly.

Preferably said attachment element is configured for removable attachment to the torch.

Preferably said adapter comprises a support wire on which the receptacle is carried.

Preferably said support wire is bendable wire, at least at a bendable middle region thereof between the attachment element and the receptacle, to reposition to the receptacle relative to said attachment element.

Preferably said support wire comprises a coiled section that defines the attachment element, and at which said support wire forms one or more coils for encircling a flame tube of the torch in a position supporting the adapter thereon.

Preferably said coiled section is neighboured by two leg portions of the wire that radiate outwardly from opposing ends of the coiled section, said coiled section having a default inner diameter in a default state of said coiled portion, and being expandable into an expanded state of greater inner diameter by forcing said leg portions of the wire together in a predetermined direction around an axis of said coiled portion.

Preferably said attachment element is configured to support the adapter on a flame tube of the torch.

Preferably said receptacle comprises an outer wall having a circumferential groove therein that is sized for engaged receipt therein of a curvingly bent portion of the support wire in a position embracing around said outer wall to support the receptacle on said support wire.

According to a second aspect of the invention, there are provided, in combination, a torch having a flame tube with an outlet end from which a flame is emitted during operation of said torch, and an adapter mounted or mountable to said torch in a position placing a receptacle of said adapter in heatable relation to said outlet end of the flame tube for heating of said receptacle by said flame during operation of said torch.

According to a third aspect of the invention, there are provided, in combination, a torch having a flame tube with an outlet end from which a flame is emitted during operation of said torch, and a receptacle carried on said torch in a position placing said receptacle in heatable relation to said outlet end of the flame tube for heating of said receptacle during operation of said torch.

### BRIEF DESCRIPTION OF THE DRAWINGS

A more complete understanding of the present invention may be had by reference to the aforementioned description and the accompanying figures submitted herewith, in which:

FIG. 1 is a side perspective view of a first embodiment of a concentrate vaporization adapter mounted to a flame tube of a handheld butane torch near a flame outlet thereof to place a receptacle of the adapter in exposed relation to the torch flame, thereby enabling vaporization of an inhalable cannabis concentrate product placed in said receptacle.

FIG. 2 is a front/side perspective view of a second embodiment of the concentrate vaporization adapter installed on the flame tube of a handheld butane torch.

FIG. 3 is a rear perspective view of the second embodiment adapter with finger grip caps thereof removed for illustrative purpose.

FIG. 4 is a side perspective view of the second embodiment adapter of FIG. 3 installed on the flame tube of the handheld butane torch.

FIG. 5 is a top perspective view of the second embodiment adapter of FIG. 4 in isolation from the butane torch.

Attention is called to the fact that the drawings are illustrative only. Variations are contemplated as being a part of the present invention, which is limited only by the scope of the claims.

### DETAILED DESCRIPTION OF PREFERRED EMBODIMENTS

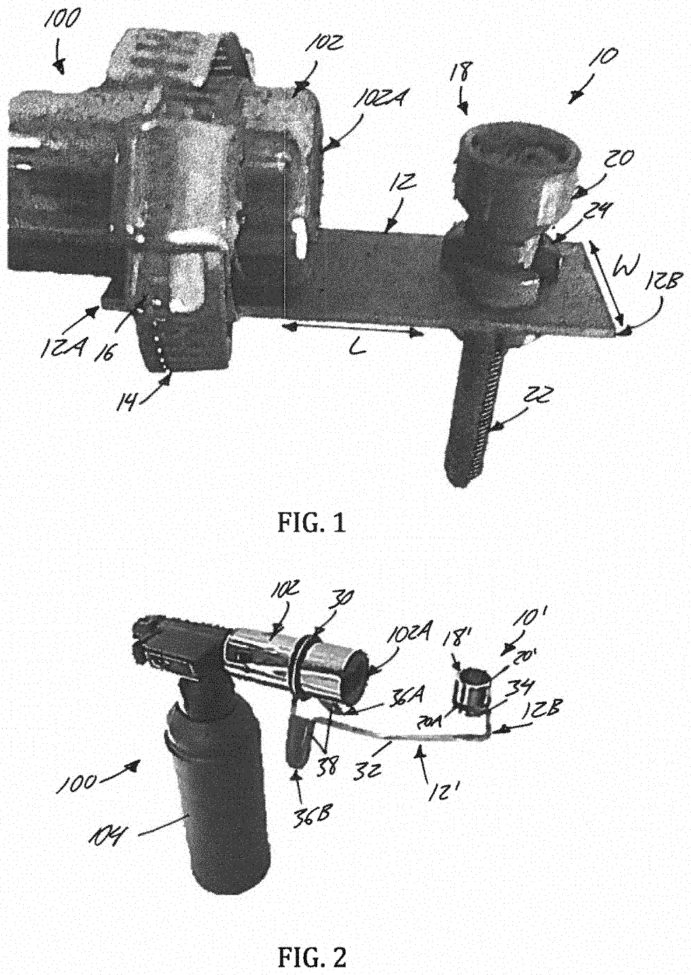

FIG. 1 illustrates a first embodiment of the invention, namely a concentrate vaporization adapter 10 that is configured to be releasably secured to a torch 100, particularly on a flame tube 102 thereof, so as to facilitate the inhalation of inhalable cannabis concentrate vapors that are released by heated vaporization of a cannabis concentrate product that is held by the adapter 10 near a flame outlet end 102A of the flame tube.

In the first embodiment, a support base 12 of the adapter is embodied in a flat, planar member made of a small piece of metal or other substantially rigid material. This support base 12 has a first end 12A and an opposing second end 12B that are separated from one another in a longitudinal direction L in which a length of the support base 12 is measured. Preferably the support base is of elongated rectangular shape, where the length of the support base 12 notably exceeds a width W of the base 12 that is measured perpendicularly transverse of the base length L. A thickness of this plate-like base 12 is measured perpendicularly transverse of its other two dimensions, and is the smallest of the base's three dimensions.

An attachment member 14 is affixed otherwise secured to, or disposed around, the base 12 at a location proximate the first end 12A thereof. The attachment member 14 of this particular embodiment is annular in shape so as to fit over the flame outlet end 102A of the torch's flame tube 102, and then mateably engage the flame tube 102 in circumferential relation therearound in order to support the attached or encircled base 12 to the flame tube 102 in a position therebeneath. The attachment member further includes a mechanical keeper 16 that assures stable securement of the attachment member to the flame tube 102 of the torch 100.

In the first embodiment, the attachment member 14 is a perforated hose clamp band formed into a closed loop, and the keeper 16 is an adjustment screw of the hose clamp whose threads engage with the cross-wise slot-shaped perforations in the hose clamp band, in a known manner, that rotation of the adjustment screw in opposing tightening and loosening directions contracts and expands the size of the closed loop of the hose clamp band, thus being operable to tighten and loosen the annular attachment member 14 around the flame tube 102 of the torch 100. The attachment member is thus adjustable in its annular size to enable selective removable fitting and securement thereof onto different torches of varying flame tube diameter.

At a longitudinal distance from the attachment member 14, at a location proximate the second end 12B of the base 12, the adapter 10 has a concentrate receptacle 18 movably secured to the base 12. In the first illustrated embodiment, the receptacle 18 includes a bowl member 20 having a hollow interior volume with an open top to enable placement of the cannabis concentrate product therein, and a stem member 22 extending axially from a closed bottom of the bowl member 20, preferably at a central point of the bowl's underside. The stem may be formed integrally of the bowl, or fabricated separately and then affixed thereto. In one instance, the concentrate receptacle is manufactured from titanium, though other materials of capable of withstanding the flame heat of the torch may alternatively be employed.

With the attachment member 14 and the receptacle 18 situated in longitudinally spaced relation to one another near opposing ends 12A, 12B of the base, securement of the attachment member 14 around the flame tube 102 of the torch 100 near the flame outlet end 102A thereof places the longitudinal direction L of the base 12 parallel to the axial direction of the flame tube 102, with the length of the base 12 spanning longitudinally outward past the flame outlet end 102A of the torch 100. This places the receptacle 18 in a position faced by the flame outlet 102A in close but spaced proximity thereto, whereby the receptacle is exposed to the flame emitted from the flame outlet 102A of the torch 100 during operation thereof. The adapter thus holds the receptacle 18 in heatable relation to the flame outlet 102A of the torch 100 so that vaporizable cannabis concentrate product placed in the bowl of the receptacle can be vaporized by the heat of the torch flame, to enable inhalation of the released cannabis concentrate vapors by the user.

In this particular embodiment, the stem 22 is externally threaded, and is cooperatively engaged in a threaded fitting 24 having an internally threaded bore that penetrates through the full thickness of the base 12 near the second end 12B thereof. Accordingly, rotation of the receptacle 18 in opposing directions is operable to raise and lower the receptacle relative to the base 12 and attachment member 14, thereby adjusting the elevational position of the receptacle 18 relative to the flame outlet end 102A of the torch's flame tube 102. Accordingly, the bowl member 20 is movable in an upwards downwards direction relative to the attachment member 14 so as to facilitate optimal placement of the receptacle in the emitted flame of various torches.

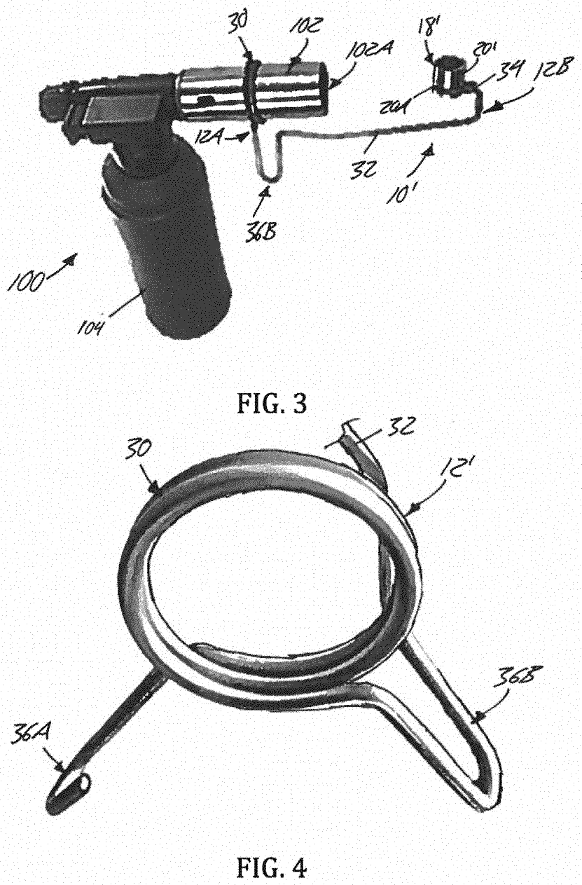

FIGS. 2 through 5 illustrate a second embodiment of the adapter 10′, which likewise features a receptacle 18′ carried on a support 12′ that is selectively and removably securable to the flame tube 102 of a handheld butane torch 100 in an installed position placing the receptacle 18′ in heatable relation to the flame outlet 102A of the torch 100. Instead of a flat rectangular base, the support 12′ of the second embodiment is instead a bendable support wire, that in sequential arrangement from the first end 12A of the support 12′ to the opposing second end 12A, features a coiled section 30, a bendable middle section 32 and a holder section 34.

At the coiled section 30, the support wire 12′ forms a coiled torsion spring whose coils are suitable sized to enable fitting over the flame outlet end 102A of flame tube 102 of the torch 100 when these spring coils are temporarily forced into a diametrically expanded state, and to then circumferentially engage tight against the circumference of the flame tube 102 when these spring coils are released back into a default contracted state of smaller diameter. To enable manual manipulation of the spring coils from their default contracted state into the larger diameter expanded state, the support wire 12 features two manipulation legs 36A, 368 that neighbour the coiled section 30 in integrally connected relation thereto at opposing ends of the spring coils.

These legs 36A, 368 radiate outwardly away from the circular spring coils at angularly spaced positions therearound, preferably with an angular measure of less than 180-degrees between the two legs for easier one-handed manipulation thereof. A user can pinch the two legs 36A, 36B between a thumb and finger (e.g. forefinger) of the same hand, and squeeze the two legs 36A, 368 toward one another, thereby expanding the spring coils into the expanded state to enabling sliding of the enlarged coil section 30 over the flame outlet 102A of the flame tube 102, whereafter the legs 36A, 368 are released, whereupon the legs angularly deflect away from one another, thus resiling from their temporarily pinched-together positions back to their normal default positions under the automatic return action imparted by the torsion spring.

In the illustrated example, each leg 36A, 36B is composed of a respective U-shaped bend in the support wire 12′ and, as shown in FIG. 2, each leg may be covered with a respective sleeve or cap 38 fitted over the U-shaped bend from the closed end of the U-shape thereof. The purpose of such sleeve or cap 38 is to enable improved finger grip of each leg during the squeezing together of the two legs while placing the coiled section 30 of the support wire onto the flame tube 102 of the torch 100. In this embodiment, the coiled section 30 thus forms an integral attachment member of the support 12′ that replaces the discrete hose clamp attachment 14 of the earlier embodiment.

The bendable middle section 32 of the support wire 12′ spans longitudinally from one of the manipulation legs 36B at the end thereof opposite the spring coils, and more particularly at a shorter side of that leg's U-shape. The middle section 32 spans in a direction of generally axial relation to the coil springs, so that when the coiled section 30 is engaged on the flame tube 102 of the torch near the flame outlet 102A thereof, the middle section 32 spans longitudinally past the flame outlet 102A in generally parallel relation to the axial direction of the flame tube 102 and a position therebeneath.

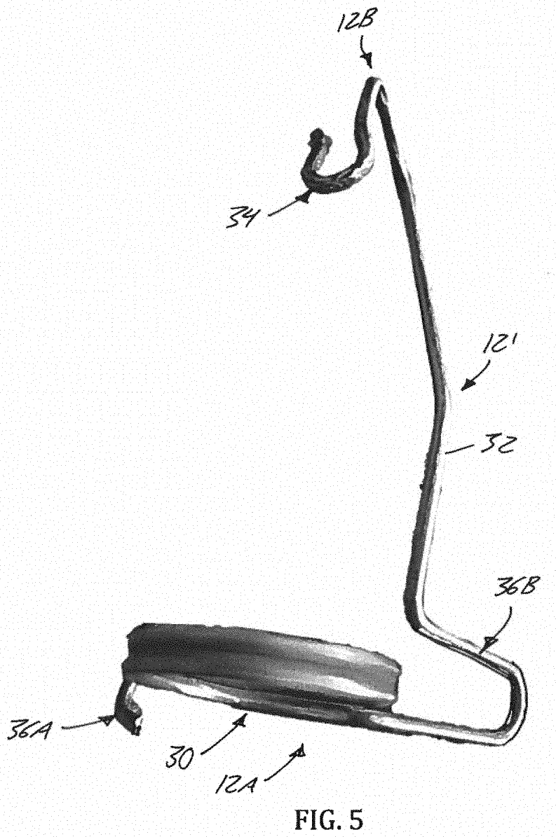

The holder section 34 of the support wire 12′ is attached to the far end of the middle section 32 by a bent stand-off 40 thereof that resides at the second end 12B o the support 12′. The holder section 34 thus resides in opposing relation to the coiled section 30 and in proximate relation to the second end 128 of the support 12′. As best shown in FIG. 5, the holder section 34 of the support wire 12′ is curvingly bent into a horseshoe-shaped hook that is held in radially offset relation from the middle section by the bent stand-off 40. The open end of the horseshoe-shaped hook faces away from the coiled section 30 and toward the second end 12B of the support 12′.

The bowl 20′ of the receptacle 18′ in this embodiment is a stemless bowl 20′ that features a circumferential groove 20A spanning around the exterior of the bowl's outer wall. This groove 20A is sized to receive the horseshoe-shaped hook of the support wire 12′. An inner diameter of the hook is less than an outermost diameter of the bowl's outer wall at areas thereof above and below the circumferential groove 20A. In a default state of the hook, the mouth of the hook at the open end thereof has a width slightly less than the outer diameter of the bowl at the circumferentially grooved area thereof. The bowl is thus insertable into the hook in snap-fit fashion during which the free end of the hook temporarily flexes away from the stand-off connected side of the hook to accommodate receipt of the bowl into the interior space of the hook, whereupon the free end of the hook resilient snaps back into its normal position. In this state, the hook circumferentially embraces the bowl in the circumferential groove thereof to hold the bowl 20′ securely on the support wire 12′.

The stand-off 40 that serves to offset the holder section 34 from the longitudinally reaching middle section 32 serves to place the hook-supported receptacle 18′ generally on the central axis of the spring coils of the coiled section 30, thereby generally aligning the receptacle 18′ with the flame outlet 102A of the torch at a proximate but spaced relation therefrom for heating of the receptacle 18′ by the emitted flame of the torch 100. The elevational position of the receptacle 18′ can once again be adjusted to fine-tune this alignment to the particular dimensions and geometry of the selected torch. However, instead of relying on a threaded connection whose rotation is operable to elevationally displace the receptacle on the support, the second embodiment enables such adjustment of the receptacle's position through user-bending of the bendable middle section 32 of the support wire 12′. Such bending is operable to displace the receptacle 18′ near the second end 12B of the support 12′ upwardly and downwardly relative to the coil-equipped, tube-mounted first end 12A of the support 12′. The support wire is sufficiently rigid at the bendable middle portion thereof to normally maintain its shape, absent application of externally applied bending forces to reshape the wire.

Both embodiments serve to effectively support a receptacle 18′ at a flame-reachable position relative to the flame outlet of the torch, and beneficially in a manner where the adapter is supported entirely from the flame tube 102 of the torch, and thus interferes neither with handheld grip of the torch 100 at the gas tank 104 thereof that doubles as the handle of the torch, nor with the torch operation controls found on the head of the torch. Both the torch and receptacle are conveniently supported in one hand thanks to the support of the adapter on the torch itself.

Preferred embodiments of the present invention have thus been fully disclosed and enabled by the forgoing description and the accompanying figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

1. An adapter for supporting a vaporizable concentrate product on a torch in a position heatable thereby to release inhalable concentrate vapor, said adapter having a first end, an opposing second end, an attachment element residing proximate said first end and configured for attachment to said torch to support the adapter thereon, and a receptacle residing proximate said second end and configured to hold said vaporizable concentrate therein.

2. The adapter of claim 1 wherein said attachment element is annular in shape.

3. The adapter of claim 1 wherein said concentrate receptacle comprises a bowl.

4. The adapter of claim 1 wherein said receptacle is movably supported.

5. The adapter of claim 1 wherein said receptacle is movable upwardly and downwardly.

6. The adapter of claim 1 wherein said attachment element is configured for removable attachment to the torch.

7. The adapter of claim 1 wherein said adapter comprises a support wire on which the receptacle is carried.

8. The adapter of claim 7 wherein said support wire is bendable wire, at least at a bendable middle region thereof between the attachment element and the receptacle, to reposition to the receptacle relative to said attachment element.

9. The adapter of claim 8 wherein said support wire comprises a coiled section that defines the attachment element, and at which said support wire forms one or more coils for encircling a flame tube of the torch in a position supporting the adapter thereon.

10. The adapter of claim 9 wherein said coiled section is neighboured by two leg portions of the wire that radiate outwardly from opposing ends of the coiled section, said coiled section having a default inner diameter in a default state of said coiled portion, and being expandable into an expanded state of greater inner diameter by forcing said leg portions of the wire together in a predetermined direction around an axis of said coiled portion.

11. The adapter of claim 7 wherein said receptacle comprises an outer wall having a circumferential groove therein that is sized for engaged receipt therein of a curvingly bent portion of the support wire in a position embracing around said outer wall to support the receptacle on said support wire.

12. The adapter of claim 1 wherein said attachment element is configured to support the adapter on a flame tube of the torch.

13. The adapter of claim 1 in combination with said torch.

14. In combination a torch having a flame tube with an outlet end from which a flame is emitted during operation of said torch, and an adapter mounted or mountable to said torch in a position placing a receptacle of said adapter in heatable relation to said outlet end of the flame tube for heating of said receptacle by said flame during operation of said torch.

15. The combination of claim 14 wherein said adapter is mounted or mountable to said flame tube of said torch.

16. The combination of claim 14 wherein said adapter comprises an annular mounting element placed or placeable around the flame tube of the torch to support said adapter thereon.

17. In combination, a torch having a flame tube with an outlet end from which a flame is emitted during operation of said torch, and a receptacle carried on said torch in a position placing said receptacle in heatable relation to said outlet end of the flame tube for heating of said receptacle during operation of said torch.

18. The combination of claim 17 wherein said receptacle is supported from said flame tube of said torch.

19. The combination of claim 17 wherein said adapter comprises an annular mounting element placed or placeable around the flame tube of the torch to support said adapter thereon.
